(19) United States
(12) Patent Application Publication
(10) Pub. No.: US 2010/0132216 A1
(43) Pub. Date: Jun. 3, 2010

(54) DRYER WITH A HEAT PUMP AND AN ELECTRICAL HEATING ELEMENT AND ALSO A METHOD FOR ITS OPERATION

(75) Inventors: Uwe-Jens Krausch, Brieselang (DE); Andreas Stolze, Falkensee (DE)

Correspondence Address: BSH HOME APPLIANCES CORPORATION;INTELLECTUAL PROPERTY DEPARTMENT, 100 BOSCH BOULEVARD, NEW BERN, NC, 28562, US

(73) Assignee: BSH BOSCH UND SIEMENS HAUSGERATE GMBH, Munich (DE)

(21) Appl. No.: 12/623,697

(22) Filed: Nov. 23, 2009

(30) Foreign Application Priority Data
Dec. 2, 2008 (DE) 10 2008 044 277.1

(51) Int. Cl. F26B 3/02; F26B 25/06; F27D 11/00

(52) U.S. Cl. 34/443; 34/218; 219/439

(57) ABSTRACT

The invention relates to a dryer with a drying chamber for the items to be dried, a process air duct, a fan in the process air duct, a heat pump with a heat sink and a heat source thermally coupled to the process air duct, and also an electrical heating element. The electrical heating element is arranged in the direct vicinity of the heat source, with a first distance between the electrical heating element and the heat source being smaller than a second distance between the electrical heating element and an entry for the process air into the drying chamber. The invention also relates to a method for operating this dryer.

### BACKGROUND OF THE INVENTION

The invention relates to a dryer with a drying chamber for the items to be dried, a process air duct, a fan in the process air duct, a heat pump with a heat sink and a heat source thermally coupled to the process air duct, and also to an electrical heating element, and also to a preferred method for its operation.

A dryer is understood in this document to be a household appliance intended for drying specific items. In particular the dryer is a tumble dryer, a washer-dryer (i.e. a combination of a washing machine and a tumble dryer) or a dishwasher.

Dryers of the generic type defined above, embodied in each case as tumble dryers, can be found in documents WO 2007/077084 A1, WO 2007/113081 A1, WO 2007/141166 A1, WO 2008/052906 A2, WO 2008/077792 A1 and WO 2008/086933 A1. In these cases the documents WO 2007/141166 A1 and WO 2008/086933 A1 relate to embodiments of a dryer in which a heat pump is combined with a normal electrical heating element and an air-air heat exchanger in each case. Such a dryer can be referred to as a “hybrid dryer”. As well as the hybrid dryer embodiment it also known that a dryer operating in quasi-stationary operation with just a heat pump can be provided with an additional electrical heating element, with this additional heating element primarily being used for accelerated heating up of the dryer when a drying process is put in train.

In a dryer air (so-called process air) is directed by a fan via a heating element into a drying chamber containing moist items. The hot air takes up moisture from the items to be dried. After its passage through the drying chamber, the then moist process air is directed into a heat exchanger, upstream of which can be located a filter, especially a lint filter, for filtering out contamination particles, especially lint in the case of a tumble dryer or washer-dryer.

This drying process is very energy-intensive, since generally the heat supplied to the process air before its application to the items to be dried is lost in energy terms to the process during the cooling of the process air in the heat exchanger. By using a heat pump this energy loss can be greatly reduced. The heat pump can serve to extract heat from the process air flowing out of the moist items which is also applied to an appropriate heat sink and to direct this heat by means of a suitable pump device to a heat source from which it reaches the process air before this is applied to the items to be dried. As an alternative, heat can also be taken by the heat sink from the surroundings of the dryer and be supplied to the process air via the heat source.

In a dryer equipped with a heat pump of the compressor type, the warm process air laden with moisture is essentially cooled down in an evaporator of the heat pump functioning as a heat sink, where the transferred heat is used for evaporation of a coolant circulating in the heat pump. The coolant evaporated as a result of the corresponding heating is supplied via a compressor to the condenser functioning as a heat source, where heat which is used for heating up the process air before entry into the drum is released because of the condensation of the gaseous coolant. The condensed coolant arrives via a choke back at the evaporator, where it evaporates by taking up heat again, by which the circuit of the coolant is closed. In the evaporator the water contained in the moist process air condenses. The condensed water is subsequently generally collected in a suitable container.

For a rapid heating up of the process air and thereby a shorter drying process overall there can be an electrical heating element present in the dryer as a well as the heat pump, so that the process air can be heated up by the heat source of the heat pump and the electrical heating element. However the space available in a dryer for arranging the individual components (“interior space”) is restricted.

GB 2 375 812 A describes a dryer device with a drying drum or another container with an inlet air duct that contains a heating element, an outlet air duct and a fan for conveying the air from the inlet air duct to the outlet air duct, with parts of this being adjacent in order to form a heat exchanger which is arranged in the inlet air duct in the direction of flow of the air above the heating element. In one embodiment the dryer contains a heat pump for transmission of heat from the outlet air duct in the direction of flow of the air below the heat exchanger to the inlet air duct above the heating element, with the heating element being arranged between the condenser of the heat pump and the drying drum.

DE 601 01 499 T2, corresponding to EP 1 154 065 B1, describes a condenser tumble dryer with a heat pump and a closed process air circuit that starts out from a tumble dryer drum and returns to the drum via an evaporator, a fan, a compressor and a condenser and also via an additional resistive heating device (W1, W2, W3). The additional resistive heating facility consists of one or more semiconductor resistors which heat up the coolant for the condenser of the heat pump circuit.

DE 42 16 106 A1 describes a tumble dryer with a washing drum, in which the process air is guided by means of a fan in a closed process air duct through the wash drum and with a heat pump circuit comprising evaporator, compressor and condenser configured for extracting the moisture carried along in the process air out of the wash drum. For the process air between the condenser and the washing drum a supplementary heating element is arranged in the process air duct.

EP 0 163 265 A2 describes a tumble dryer with a washing drum and a fan unit which conveys the process air through the dryer, and also with a heating facility for heating up the process air. Arranged on the outer side in the upper area of the rear wall is a heating element unit with an inlet air connection and accommodated in the lower area of the dryer is an outlet air connection exiting to the rear or sideways, with supplementary units able to be connected between inlet air connection and outlet air connection.

### BRIEF SUMMARY OF THE INVENTION

An object of the present invention is to provide a dryer in which the individual components of the dryer (such as electrical heating element and heat source for example) can be arranged in a space-saving yet still efficient manner.

The invention relates to a dryer with a drying chamber for items to be dried, a process air duct, a fan in the process air duct, a heat pump with a heat sink and a heat source thermally coupled to the process air duct, and also an electrical heating element, arranged in the direct vicinity of the heat source, with a first distance between the electrical heating element and the heat source being smaller than a second distance between the electrical heating element and an entry for the process air into the drying chamber.

In this context “directly adjacent to the heat source” especially means that no other components of the dryer are located between the heat source and the electrical heating element, so that the process air flows from the heat source via the process air duct directly to the electrical heating element.

The “first distance” is generally the smallest distance between a surface of the electrical heating element and a surface of the heat source. Likewise the “second distance” is generally the smallest distance between a surface of the electrical heating element and an entry into the drying chamber. A ratio between the second distance and the first distance preferably amounts to between 1.5 and 20 and most especially preferably between 2 and 10.

The first distance preferably amounts to 1.5 to 20 cm and especially preferably to 3 to 10 cm.

The electrical heating element can be embodied as an open or closed heating element (e.g. an open coiled heating element), with “open” meaning that the heating of the process air uses a part conducting an electrical voltage, while “closed” means that the process air is heated up by a part not conducting an electrical voltage which is in its turn heated up by a part conducting an electrical voltage.

Preferably the electrical heating element is a closed heating element, e.g. a tubular heating element, in which a part conducting an electrical voltage is encapsulated in a ceramic surround, or a PTC heating element. It is especially preferred for a PTC (Positive Temperature Coefficient) heating element to be used as a closed heating element. This has the advantage of a comparatively low surface temperature. In addition the particular temperature dependence of the electrical resistance with PTC heating elements (initially a drop in the electrical resistance with increasing temperature, followed by a sharp rise of the electrical resistance with a further temperature increase) leads to an especially secure ability to regulate the electrical heating element.

A PTC heating element can especially be used to advantage in a dryer embodied as a vented-air dryer, since in this device lint-free ambient air, e.g. from a room in which the dryer is sited, is sucked in and heated up. This is especially advantageous, because a PTC heating element, as a result of its construction which frequently includes fins, tends to attract lint.

In a preferred embodiment of the invention the heat source and the electrical heating element are arranged in a common component. It is of especial advantage here for a closed electrical heating element to be used.

The dryer of the invention can be embodied as a recirculating-air dryer or as a vented-air dryer. In the case of the recirculating-air dryer the process air circuit is essentially self-contained, and also the heat sink is thermally coupled to the process air circuit. It serves to cool down process air laden with moisture for the purposes of removal of the moisture. Preferably the dryer is embodied as a vented-air dryer. In this case the process air circuit is open with, when the process air to be taken away from the process air circuit is laden with moisture, care possibly having to be taken that this process air to be taken away is not simply let out into a closed building in which the dryer is set up, but is taken away out of the building by a suitable ventilation system, in the simplest case a corresponding hose. With a vented-air dryer, as in the recirculating-air dryer, the heat sink can be coupled thermally to the process air circuit. It is likewise conceivable with the vented-air dryer to provide the heat sink without thermal coupling to the process air circuit, in which case it could serve to extract heat from air taken from the environment of the dryer for introduction into the process air circuit.

Inventively it is of advantage for the fan to be arranged between an inlet air access and the heat source or between the heat sink and an exhaust air outlet. Preferably the fan is arranged between the inlet air access and the heat source.

It is inventively especially preferred for the heat source and the electrical heating element to be arranged in the process air duct such that the process air can flow from the heat source to the heating element with an essentially laminar flow.

The inventive dryer preferably has an acoustic and/or optical display means for displaying one or more operating states. An optical display means can for example be a liquid crystal display on which specific requirements or information are specified. Also or as an alternative light emitting diodes can illuminate in one or more colors.

The inventive dryer can comprise an air-air heat exchanger which is preferably embodied to be removable. This is especially advantageous since lint can be cleaned off a removable heat exchanger more easily.

The heat pump of the dryer preferably corresponds to the compressor heat pump type. To this end it is configured for circulating a coolant through the heat sink, which is an evaporator for the coolant, a compressor which is configured for compressing the coolant and driving the coolant through the heat pump, the heat source which is a condenser for the coolant, and a choke for expanding the coolant. Fluorinated hydrocarbons, especially the fluorinated ethane derivatives R134a and R152a, mixtures of fluorinated hydrocarbons such as the known compounds R407C and R410A and also propane (R290) and carbon dioxide (R744) are considered as coolants.

The temperature of the coolant of the heat pump, especially in the condenser, is generally held within the permitted range via the control of the heat pump, and if necessary an additional air-air heat exchanger.

Since, as the degree of drying of the objects to be dried in the dryer progresses, the necessary energy for the drying decreases, it is expedient to regulate the heating element accordingly, i.e. with ongoing degree of drying to reduce its heating power in order to maintain an equilibrium between the drying energy supplied and the energy necessary.

As the degree of drying of the objects to be dried increases, especially of the washing, a lower heat output or even an increasing cooling power of the heat pump is necessary. In particular the temperature in the process air circuit would rise sharply after a completed drying phase. In general the heat pump and the electrical heating element will thus be regulated in the dryer so that a maximum permitted temperature is not exceeded in the drying chamber.

For monitoring the temperature of coolant or heat pump and also if necessary the temperature of the process air, temperature sensors generally known per se to the person skilled in the art are employed in the heat pump circuit and/or in the process air circuit.

Preferably the controller of the heat pump and the controller of the electrical heating element are integrated into a program control of the dryer.

Inventively it is preferred that process air and cooling air or process air and coolant respectively be guided in the heat pump in a crossflow or contraflow method respectively through the corresponding heat exchangers.

Also specified in accordance with the invention is a method for operating a dryer with a drying chamber for the items to be dried, a process air duct, a fan in the process air duct, a heat pump with a heat sink and a heat source thermally coupled to the process air duct, and also an electrical heating element that is arranged in the direct vicinity of the heat source, with a first distance between the electrical heating element and the heat source being smaller than a second distance between the electrical heating element and an entry for the process air into the drying chamber, in which method the process air is initially heated by the condenser and subsequently by the electrical heating element and is then directed into the drying chamber.

In a preferred embodiment of the inventive method the process air is directed from the condenser to the heating element with an essentially laminar flow.

The invention has the advantage that a dryer with an optimized utilization of the available space is provided. Over and above this the flow of process air onto the electrical heating element can be optimized, so that for example the occurrence of damaging temperature peaks is minimized. In this case it is inventively of advantage for the optimization of the flow of the process air to the electrical heating element to be able to be achieved in a simple manner, namely by using the condenser. For example when a condenser with heat exchanger plates is used, a more even inflow onto the electrical heating element can be implemented.

### BRIEF DESCRIPTION OF THE DRAWINGS

Further details of the invention emerge from the description given below of non-restrictive exemplary embodiments for a dryer and for a method employing this dryer. These embodiments refer to FIGS. 1 to 2.

FIG. 1 shows a vertical section through a dryer according to a first embodiment, in which the dryer is embodied as a vented-air dryer.

FIG. 2. shows a vertical section through a dryer according to a second embodiment, in which the dryer is likewise embodied as a vented-air dryer.

### DETAILED DESCRIPTION OF EXEMPLARY EMBODIMENTS OF THE PRESENT INVENTION

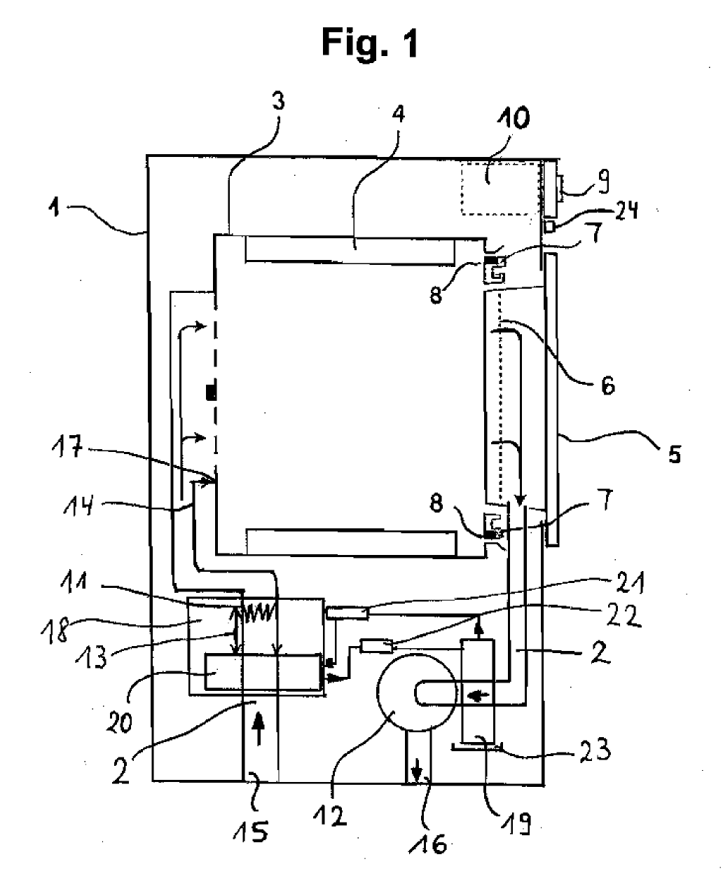

FIG. 1 shows a vertical section through a dryer 1 according to a first embodiment, in which the dryer 1 is embodied as a vented-air dryer and a fan is arranged before an exhaust air outlet. The dryer 1 has a drum rotatable about a horizontal axis as its drying chamber 3, within which agitators 4 are attached for moving the washing during a drum rotation. Process air is conducted by means of a fan 12 starting from an inlet air entry 15 through the drum 3 and also a heat pump 19, 20, 21, 22 in a process air duct 2. After passing through the drum 3, the moist, warm process air is cooled and after condensation of the moisture contained in the process air in an evaporator 19 of the heat pump 19, 20, 21, 22, is directed via an exhaust air outlet 16 into the room where the dryer 1 is sited. The process air is heated up in this case with a condenser 20 of the heat pump 19, 20, 21, 22 and also an electrical heating element 11 arranged in its direct vicinity. The heated-up process air is directed from behind, i.e. from a side of the drum 3 lying opposite a dryer door 3, through its perforated floor into the drum 3, comes into contact with the washing to be dried and flows through the filler opening of the drum 3 to a lint filter 5 within a dryer door 6 closing off the filler opening. Subsequently the air flow is directed downwards in the door 5 and guided onwards in the air duct 2 to the evaporator 19 of the heat pump 19, 20, 21, 22, where it is cooled. A coolant circulating in the heat pump 19, 20, 21, 22, in this example R407C, is evaporated for this purpose in the evaporator 19 and is directed via a compressor 21, which compresses it and drives it through the heat pump 19, 20, 21, 22 to the condenser 20. In the condenser 20 the coolant condenses while releasing heat to the process air. The coolant now present in liquid form is subsequently directed via a choke 22 back to the evaporator 19 where it evaporates once more, by which the coolant circuit is closed. Below the evaporator 19 is a condensate tray 23, which catches condensate occurring during the cooling of the moist, warm process air. The condensate can for example be disposed of by mechanical emptying of the tray or by pumping it out from the condensate tray 23.

The part of the process air duct 2 from the inlet air entry 15 to the drum 3 is also referred to as the inlet air duct and the part of the process air duct 2 from the drum 3 to the exhaust air outlet 16 as the outlet air duct.

The drum 3 in the exemplary embodiment shown in FIG. 1 is supported on the rear base by means of a rotary bearing and at the front by means of an end bearing shield 7, with the drum 3 resting with a flange on a slider strip 8 on the end shield 7 and being held in this way at its front end.

The dryer 1 is controlled via a program control 10 which can be regulated by the user via a control unit 9. Different states of the dryer 1 can be shown optically or acoustically by means of a display device 24.

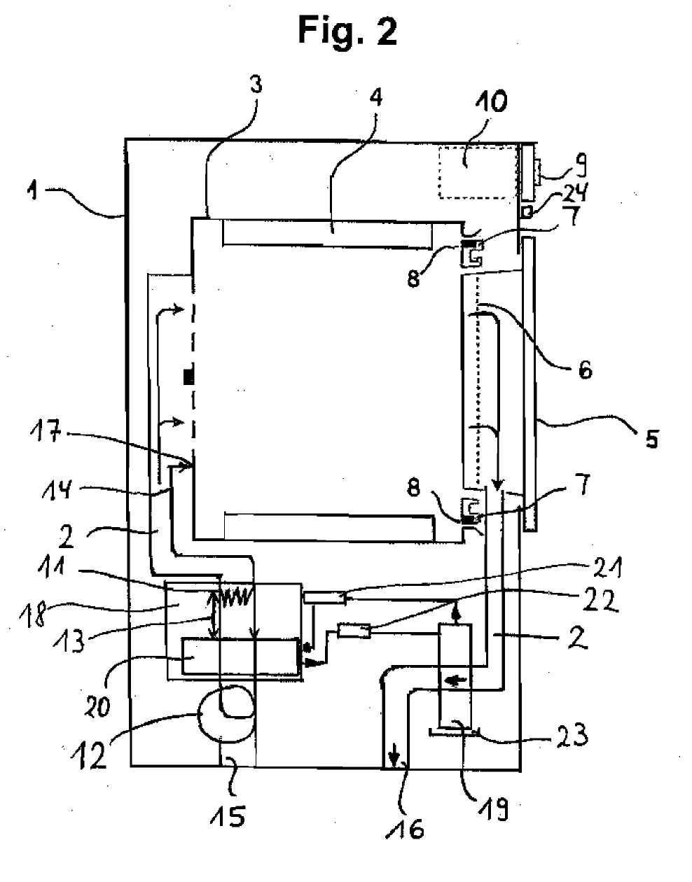

FIG. 2 shows a vertical section of a dryer 1 according to a second embodiment in which the dryer 1 is embodied as a vented-air dryer 1 and a fan 12 is arranged behind an inlet air access 15.

The single difference between the first embodiment shown in FIG. 1 and the second embodiment shown in FIG. 2 thus lies in the different arrangement of the fan 12. In FIG. 2. the fan 12 is namely located between an inlet air access 15 and the condenser 20.

1. A dryer comprising:
a drying chamber;
a process air duct in communication with the drying chamber;
a fan in the process air duct;
a heat pump with a heat sink and a heat source thermally coupled to the process air duct; and
an electrical heating element in a direct vicinity of the heat source, wherein a first distance between the electrical heating element and the heat source is smaller than a second distance between the electrical heating element and an entry for the process air into the drying chamber.

2. The dryer of claim 1, wherein a ratio between the second distance and the first distance amounts to between 1.5 and 20.

3. The dryer of claim 1, wherein the electrical heating element is a closed heating element.

4. The dryer of claim 3, wherein the closed heating element is a Positive Temperature Coefficient heating element.

5. The dryer of claim 1, wherein the condenser and the electrical heating element are arranged in a common component.

6. The dryer of claim 1, wherein the dryer comprises a vented-air dryer.

7. The dryer of claim 6, wherein the fan is arranged between an inlet air access and the heat source or between the heat sink and an exhaust air outlet.

8. The dryer of claim 1, wherein the heat source and the electrical heating element are arranged in the process air duct so that the process air can flow in an essentially laminar manner from the heat source to the electrical heating element.

9. The dryer of claim 1, wherein the heat pump is configured to circulate a coolant through the heat sink, which is an evaporator for the coolant, a compressor which is configured to compress the coolant and drive the coolant through the heat pump, the heat source which is a condenser for the coolant, and a choke for expanding the coolant.

10. A method for operating a dryer with a drying chamber for the items to be dried, a process air duct, a fan in the process air duct, a heat pump with a heat sink and a heat source thermally coupled to the process air duct, and also an electrical heating element which is arranged in the direct vicinity of the heat source, with a first distance between the electrical heating element and the heat source being smaller than a second distance between the electrical heating element and an entry for the process air into the drying chamber, the method comprising:
heating up process air with the condenser;
subsequently heating up the process air with the electrical heating element; and
directing the heated air into the drying chamber.

11. The method of claim 10, further comprising directing the air from the condenser to the electrical heating element with an essentially laminar flow.
